(19) United States
(12) Patent Application Publication
(10) Pub. No.: US 2025/0209395 A1
(43) Pub. Date: Jun. 26, 2025

(54) MAN-HOUR INPUT PLAN GENERATION SYSTEM AND MAN-HOUR INPUT PLAN GENERATION METHOD

(71) Applicant: Hitachi Astemo, Ltd., Hitachinaka-shi, Ibaraki (JP)

(72) Inventors: Akihiro HORI, Chiyoda-ku, Tokyo (JP); Masumi KAWAKAMI, Chiyoda-ku, Tokyo (JP); Hajime SAITO, Hitachinaka-shi, Ibaraki (JP); Tomomi OKAMOTO, Hitachinaka-shi, Ibaraki (JP); Shigeru NAOI, Hitachinaka-shi, Ibaraki (JP); Tomoaki NAKAMURA, Hitachinaka-shi, Ibaraki (JP)

(73) Assignee: Hitachi Astemo, Ltd., Hitachinaka-shi, Ibaraki (JP)

(21) Appl. No.: 18/846,964

(22) PCT Filed: Feb. 8, 2023
(86) PCT No.: PCT/JP2023/004150

§ 371 Date: Sep. 13, 2024

(30) Foreign Application Priority Data
May 19, 2022 (JP) 2022-082065

(51) Int. Cl. G06Q 10/0631; G06Q 10/10

(52) U.S. Cl. CPC G06Q 10/063118; G06Q 10/103

(57) ABSTRACT

Provided is a man-hour input plan generation system provided with a calculation device that executes predetermined calculation processing and a storage device which has a program stored therein and is connected to the calculation device, the man-hour input plan generation system including an input section in which the calculation device receives input of a man-hour input plan directed to a project, an analysis section in which the calculation device analyzes the input man-hour input plan, and an output section in which the calculation device outputs an analysis result obtained by the analysis section, in which the input section receives input of, as the man-hour input plan, time series data associating a man-hour input amount and an input time with each other.

### INCORPORATION BY REFERENCE

This application claims priority from Japanese Patent Application No. 2022-82065 filed on May 19, 2022, the content of which is hereby incorporated by reference into this application.

### TECHNICAL FIELD

The present invention relates to a man-hour input plan generation system and more particularly to a technology of predicting the total man-hour effort and the quality of a project.

### BACKGROUND ART

In a software development project, a project planner plans, in advance, a man-hour effort to be input to the project. Ideally, the quality of a product is increased by inputting a sufficient man-hour effort, a rework man-hour effort decreases, and hence, the total man-hour effort can consequently be suppressed. However, a human resource of an organization is actually limited, and hence, there, is a case in which a sufficient man-hour effort cannot be input. In this case, the project planner is required to set a man-hour input plan which satisfies the quality and the total man-hour effort which are allowed to be compromised within a range of the human resource of the organization. Thus, the project planner predicts the quality and the total man-hour effort from the man-hour input plan set within the human resource of the organization and determines whether or not the predicted quality and total man-hour effort can be compromised. When they cannot be compromised, the project planner again sets the man-hour input plan within the human resource of the organization, predicts the quality and the total man-hour effort, and determines whether or not the predicted quality and total man-hour effort can be compromised. Until the predicted result of the quality and the total man-hour effort become ones which can be compromised, this work is repeated.

As background art in the field of the present technology, there is the following prior art. In Patent Document 1 (Japanese Patent Laid-Open No. 2011-170496), there is described a work plan support device for plant, the work plan support device supporting plan creation for construction work or update work for a plant including a plurality of components to be installed in a construction area. The work plan support device includes database means which accumulates a plurality of pieces of performance data on work executed in the past, input means which inputs a type and a work portion of a work target which is the same as or similar to planned work, performance data extraction means which extracts, from the database means, the performance data on the past work corresponding to the type and the work portion of the work target input by the input means, and plan creation means which uses the performance data extracted by the performance data extraction means to create a process plan table to which a work content of the planned work and a time series sequence thereof are set.

### SUMMARY OF THE INVENTION

### Problems to be Solved by the Invention

In Patent Document 1, the total man-hour effort of new work is predicted on the basis of the performance data on the work executed past, thereby creating the process plan table. However, when this is applied to a software development project, there is room for increasing a prediction accuracy of the total man-hour effort. This is because, in the software development project, an amount of bugs subsequently mixed in can be suppressed by inputting a large amount of man-hour effort on an upstream process such as demand analysis and base design, the number of times of rework can hence be suppressed in a subsequent process, and the total man-hour effort can consequently be reduced. That is, a time-series man-hour input amount which associates the man-hour input amount and the input time thereof with each other affects the total man-hour effort, but, in Patent Document 1, the total man-hour effort is not predicted through use of the time-series man-hour input amount, and hence, there is room for increasing the accuracy in this respect.

In view of the above-mentioned problem, according to the present invention, a time-series man-hour input amount which associates a man-hour input amount and an input time thereof with each other is received as input, and at least one of the total man-hour effort and the quality is predicted through use of the time-series man-hour input amount.

### Means for Solving the Problems

A representative example of the invention disclosed in the present application is described as follows. That is, such a representative example is a man-hour input plan generation system provided with a calculation device that executes predetermined calculation processing and a storage device which has a program stored therein and is connected to the calculation device, the man-hour input plan generation system including an input section in which the calculation device receives input of a man-hour input plan directed to a project, an analysis section in which the calculation device analyzes the input man-hour input plan input from the calculation device, and an output section in which the calculation device outputs an analysis result obtained by the analysis section, in which the input section receives input of, as the man-hour input plan, time series data associating a man-hour input amount and an input time with each other.

### Advantages of the Invention

According to the one aspect of the present invention, the prediction accuracy of the total man-hour effort and the quality can be increased. Problems, configurations, and effects other than the description given above become apparent from the following description of embodiments.

### BRIEF DESCRIPTION OF THE DRAWINGS

FIG. 1 is a diagram for illustrating an example of a flow and display of processing of a project total man-hour effort/quality prediction simulation system according to an embodiment 1.

FIG. 2 is a table for illustrating an example of man-hour input data according to the embodiment 1.

FIG. 3 is a table for illustrating an example of characteristic data according to the embodiment 1.

FIG. 4 is a table for illustrating an example of milestone data according to the embodiment 1.

FIG. 5 is a table for illustrating an example of past data according to the embodiment 1.

FIG. 6 is a table for illustrating the example of the past data according to the embodiment 1.

FIG. 7 is a table for illustrating the example of the past data according to the embodiment 1.

FIG. 8 is a table for illustrating the example of the past data according to the embodiment 1.

FIG. 9 is a table for illustrating an example of data held by an analysis section according to the embodiment 1.

FIG. 10 is a table for illustrating an example of the data held by the analysis section according to the embodiment 1.

FIG. 11 is a table for illustrating an example of data displayed by an output section according to the embodiment 1.

FIG. 12 is a flowchart of processing of calculating an ideal man-hour input plan of a target project according to the embodiment 1.

FIG. 13 is a flowchart of processing of calculating future total man-hour effort, number of bugs, productivity, bug density, and development period for an original man-hour input plan according to the embodiment 1.

FIG. 14 is a flowchart of processing of calculating future total man-hour effort, number of bugs, productivity, bug density, and development period in an ideal man-hour input plan according to the embodiment 1.

FIG. 15 is a flowchart of processing of calculating future total man-hour effort, number of bugs, productivity, bug density, and development period in a simulated man-hour input plan of this project according to the embodiment 1.

FIG. 16 is a chart for illustrating an example of “man-hour input patterns” according to the first embodiment.

### MODES FOR CARRYING OUT THE INVENTION

A description is now given of embodiments with reference to the drawings. Note that the embodiments described now do not limit the present invention according to the scope of the claims. All of respective elements described in the embodiments and combinations thereof are not always indispensable as solution of the invention.

### Embodiment 1

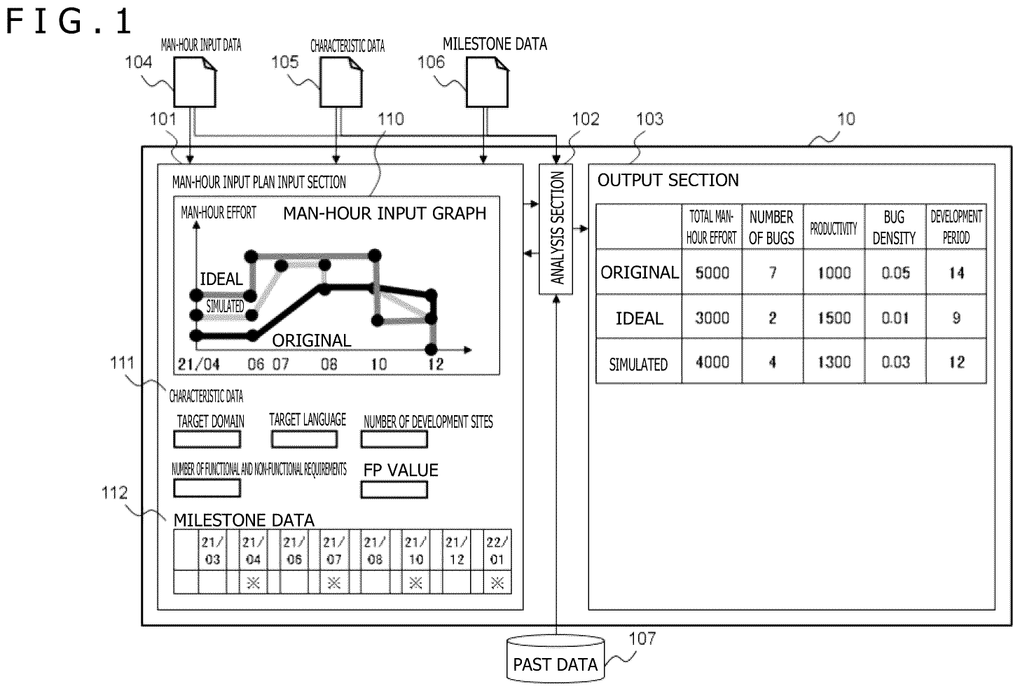

FIG. 1 is a diagram for illustrating an example of a flow and display of processing of a project total man-hour effort/quality prediction simulation system 10.

The project total man-hour effort/quality prediction simulation system 10 includes a man-hour input plan input section 101, an analysis section 102, and an output section 103.

When the man-hour input plan input section 101 reads man-hour input data 104, characteristic data 105, and milestone data 106, the man-hour input plan input section 101 displays the man-hour input data 104 as an original man-hour input plan, the characteristic data 105 as characteristic data 111, and the milestone data 106 as milestone data 112 in a man-hour input graph 110. The man-hour input data 104, which is the man-hour input plan, is represented as time series data associating a man-hour input amount and an input time thereof with each other. After that, the analysis section 102 reads the man-hour input data 104, the characteristic data 105, the milestone data 106, and past data 107, calculates an ideal man-hour input plan, and displays the calculated ideal man-hour input plan as an ideal man-hour input plan in the man-hour input graph 110. After that, a user edits the original man-hour input plan in the man-hour input graph 110 on a GUI of the man-hour input plan input section 101. The man-hour input amount after the editing is displayed as a simulated man-hour input plan independently of the original man-hour input plan. The man-hour input plan input section 101 provides the GUI for the editing by the user. Through use of this GUI, the user operates, in an upward or downward direction, an edit point indicating an input man-hour effort for each period, thereby allowing the man-hour input amount to be edited.

After the editing of the man-hour input amount, the analysis section 102 additionally reads the original man-hour input plan, the ideal man-hour input plan, and the simulated man-hour input plan displayed in the man-hour input graph 110, calculates future total man-hour effort, number of bugs, productivity, bug density, and development period, and causes them to be displayed on the output section 103. In terms of a display form, any one of a text form, a table form, a graph form, and a chart form may be employed. Subsequently, in response to the editing of the simulated man-hour input plan by the user in the man-hour input graph 110 on the GUI of the man-hour input plan input section 101, the analysis section 102 executes the analysis, thereby updating the display content of the output section 103.

The project total man-hour effort/quality prediction simulation system 10 is implemented in a computer including a processor, a memory, an auxiliary storage device, and a communication interface. The processor is a calculation device which executes programs stored in the memory. Functions provided by the project total man-hour effort/quality prediction simulation system 10 are implemented by the processor executing the various types of program. Note that a part of processing executed by the processor executing the programs may be executed by another calculation device (for example, hardware such as an ASIC and an FPGA). The memory includes a ROM being a nonvolatile storage device and a RAM being a volatile storage device. The ROM stores invariable programs (for example, a BIOS). The RAM is a high-speed and volatile storage device such as a DRAM (Dynamic Random Access Memory) and temporarily stores the programs executed by the processor and data used when the programs are executed. The auxiliary storage device is a high-capacity and nonvolatile storage device such as a magnetic storage device and stores the programs executed by the processor and the data used by the processor when the programs are executed. The communication interface is a network interface device which controls communication with another device according to a predetermined protocol.

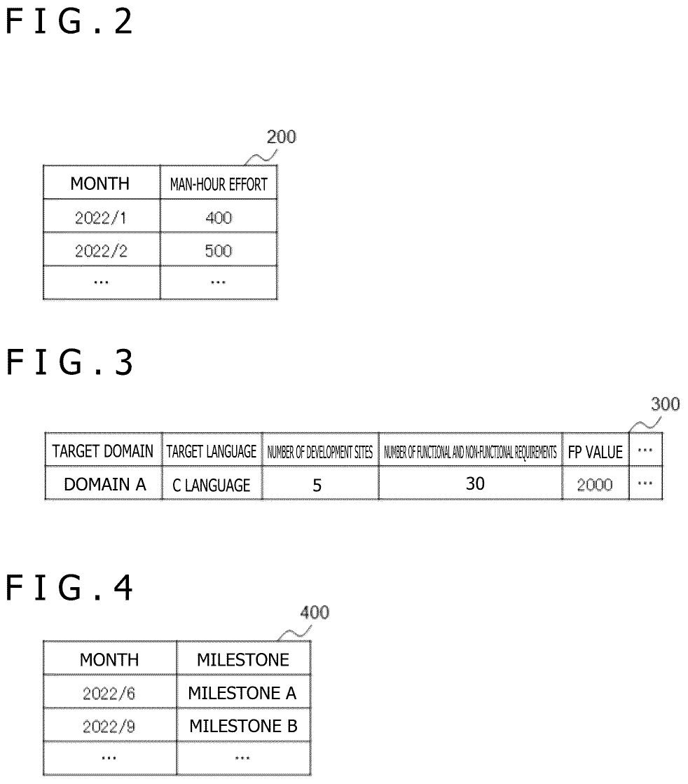

FIG. 2 is a table for illustrating an example of the man-hour input data 104. The man-hour input data 104 records, for a project for which the user wants to create a man-hour input plan, the man-hour input plan at the current time in, for example, a table form. In a column of “month,” a future month and, in a column of “man-hour effort,” the man-hour effort planned to be input in this month at the current time in this project are recorded.

FIG. 3 is a table for illustrating an example of the characteristic data 105. In the characteristic data 105, quantitative data and qualitative data indicating the characteristics of the project for which the user wants to create the man-hour input plan are recorded. For example, a target domain, a target language, the number of development sites, the number of functional and non-functional requirements, an FP value, and the like should be recorded.

FIG. 4 is a table for illustrating an example of the milestone data 106. The milestone data 106 records, for the project for which the user wants to create the man-hour input plan, milestones in, for example, a table form. In a column of “month,” a month to which a milestone is set in this project and, in a column of “milestone,” the milestone of this project set to this month are recorded.

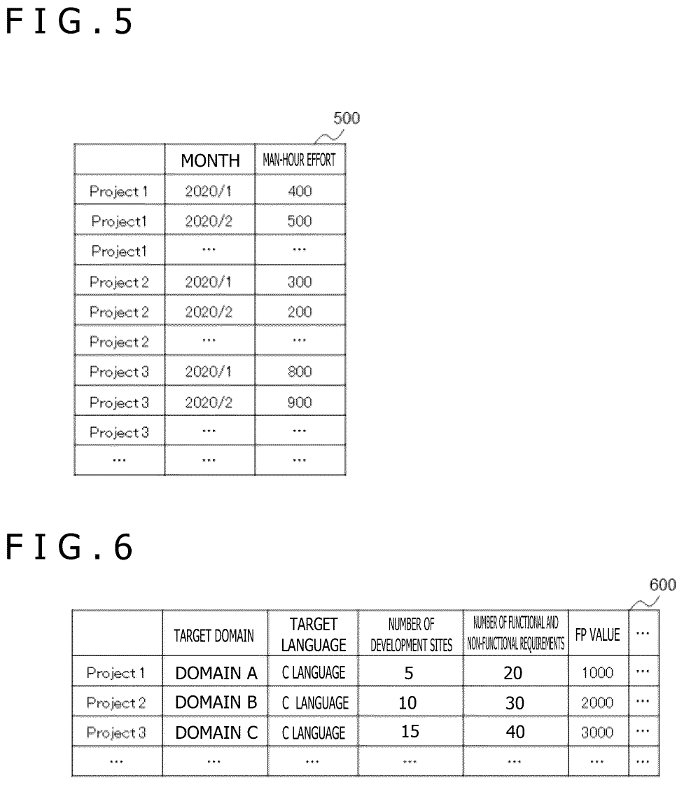

FIG. 5 to FIG. 8 are tables for illustrating an example of the past data 107. For example, the past data 107 may be formed of a plurality of tables illustrated in FIG. 5 to FIG. 8.

A part of the past data 107 illustrated in FIG. 5 is data on man-hour input performance of projects executed in the past. In a column of “project,” a name of the project, in a column of “month,” a month in which the man-hour effort occurred, and, in a column of “man-hour effort,” the man-hour effort input in this month in this project are recorded.

A part of the past data 107 illustrated in FIG. 6 is the characteristic data on the projects executed in the past. In a column of “project,” the name of the project and, in other columns, characteristic values of this project are recorded. For example, the target domain, the target language, the number of development sites, the number of functional and non-functional requirements, the FP value, and the like should be recorded.

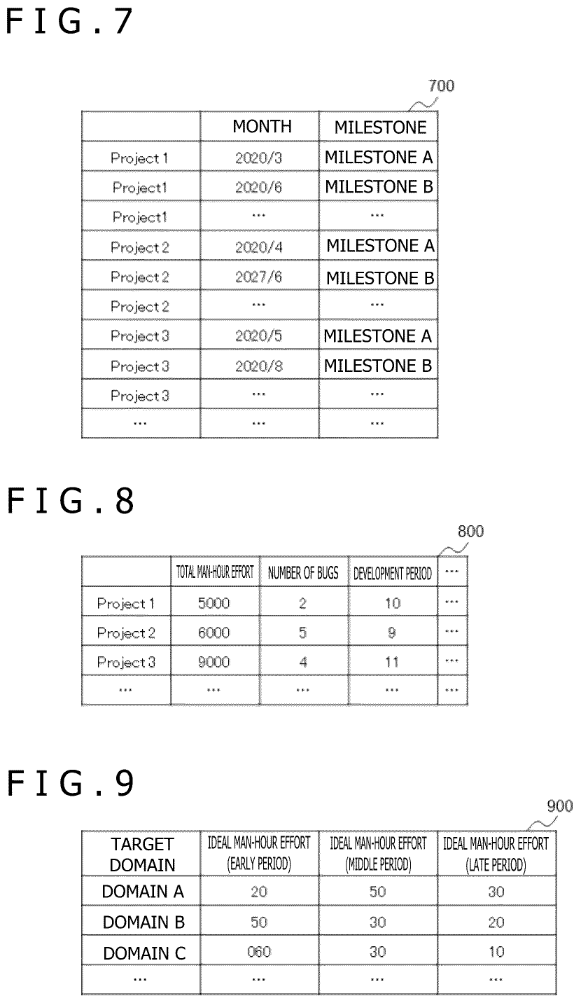

A part of the past data 107 illustrated in FIG. 7 is the milestone data on the projects executed in the past. In a column of “project,” the name of the project, in a column of “month,” the month to which the milestone is set in this project, and, in a column of “milestone,” the milestone of this project set to this month are recorded.

A part of the past data 107 illustrated in FIG. 8 is data on final total man-hour effort, quality, and the like of the projects executed in the past. In a column of “project,” the name of the project, in a column of “total man-hour effort,” the final total man-hour effort of this project, in a column of “number of bugs,” the final number of bugs of this project, and, in a column of “development period,” a final development period of this project are recorded.

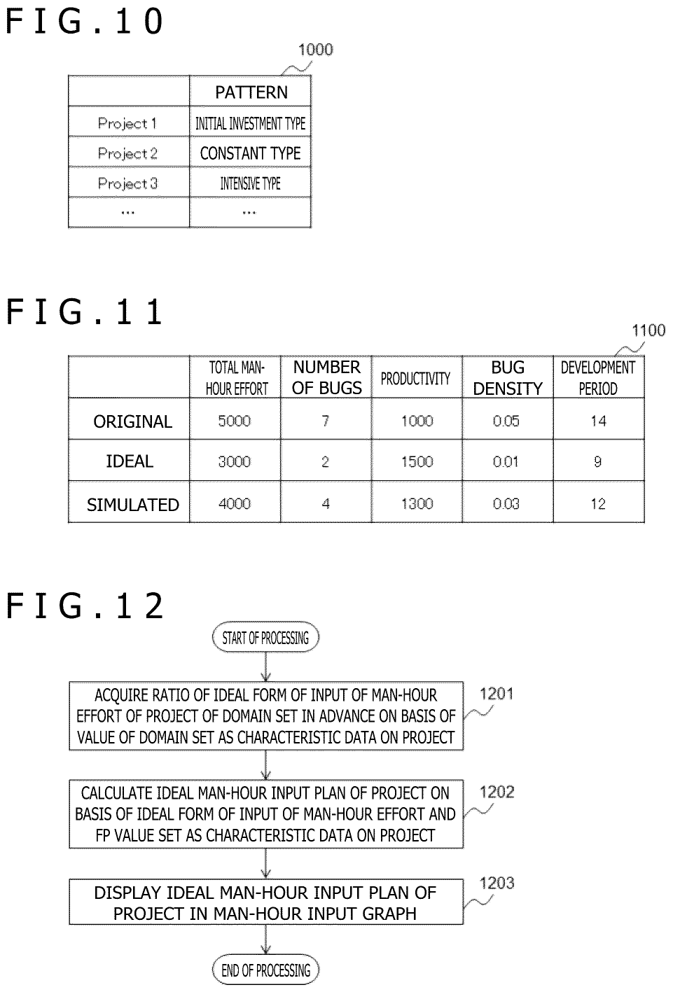

FIG. 9 and FIG. 10 are tables for illustrating an example of data held by the analysis section 102.

The data illustrated in FIG. 9 is data in which the ideal input man-hour efforts in an early period, a middle period, and a late period of the project for each domain are defined. In a column of “target domain,” the domain and, in other columns, the ideal input man-hour effort in each stage of the project while the FP value is set to 100 are recorded.

Data illustrated in FIG. 10 is data on a pattern classification result of the past projects. In a column of “project,” the name of the project and, in a column of “pattern,” the pattern classification result of this project are recorded.

FIG. 11 is a table for illustrating an example of the data displayed by the output section 103.

The output section 103 indicates a calculation result of the future total man-hour effort, number of bugs, productivity, bug density, and development period for the original, ideal, and simulated man-hour input plans for the project input by the user. In an left-end column, a classification which is the original, the ideal, or the simulated, in a column of “total man-hour effort,” the total man-hour effort in this classification of this project, in a column of “number of bugs,” the number of bugs in this classification of the project, in a column of “productivity,” the productivity of this classification of this project, in a column of “bug density,” the bug density of this classification of this project, and in a column of “development period,” the development period of this classification of this project are displayed. The columns for these items are an example, and columns for other items may be displayed.

FIG. 12 is a flowchart of processing of calculating, by the analysis section 102, the ideal man-hour input plan for the input target project.

The analysis section 102 acquires, on the basis of the value of the domain set as the characteristic data 105 on this project, definition of an ideal form of the input of the man-hour effort set in advance to the project in the domain (1201). The ideal form of the input of the man-hour effort should be represented as a ratio.

The analysis section 102 calculates the ideal man-hour input plan of this project on the basis of the definition of the ideal form of the input of the man-hour effort and the FP value set as the characteristic data 105 on this project. As a calculation method for the ideal man-hour input plan, also adoptable is a calculation method of calculating a coefficient indicating a multiple of the FP value of this project with respect to a criterion while estimating that a relation between the FP value and the total man-hour effort is linear, multiplying the definition of the ideal form of the input of the man-hour effort by this coefficient to acquire an ideal man-hour effort in each of the early period, the middle period, and the late period of this project, and further interpolating the acquired man-hour effort. As another example, adoptable is a method of calculation while estimating the relationship between the FP value and the man-hour effort is nonlinear (1202).

After that, the calculated ideal man-hour input plan of this project is displayed as the ideal man-hour input plan by the man-hour input plan input section 101 (1203).

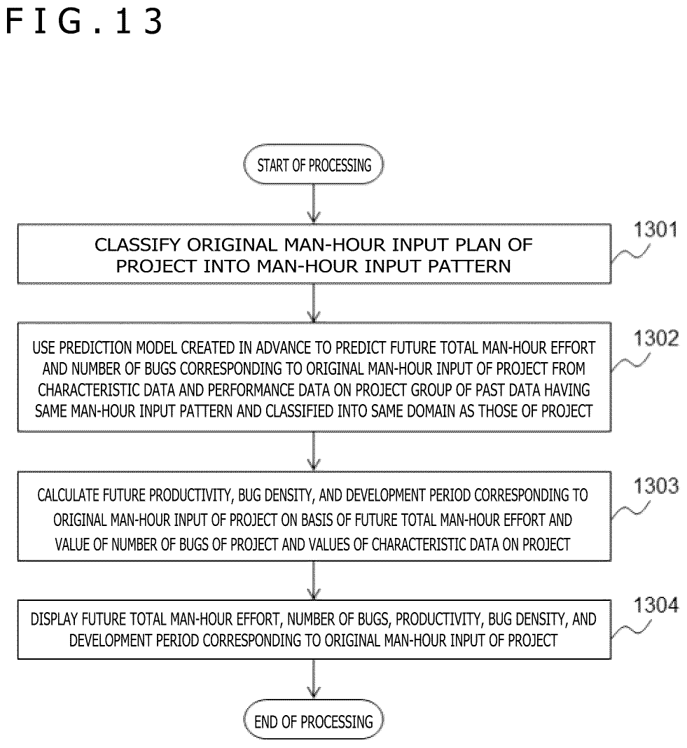

FIG. 13 is a flowchart of processing of calculating, by the analysis section 102, future total man-hour effort, number of bugs, productivity, bug density, and development period for the original man-hour input plan displayed in the man-hour input graph 110.

The analysis section 102 collates the input man-hour effort of the original man-hour input plan of this project displayed by the man-hour input plan input section 101 with the plurality of man-hour input patterns stored in advance, thereby classifying the input man-hour effort into a man-hour input pattern (1301). As the method of classifying into a pattern, a method of employing an equation in an ideal form calculated from an average of a shape of the man-hour input plan, a method based on the definition of the flag, pattern matching of the shape of the man-hour input plan, or other methods can be employed.

The analysis section 102 uses a prediction model created in advance from the characteristic data and the performance data on the project group of the past data 107 having the same man-hour input pattern and classified into the same domain as those of this project to predict the future total man-hour effort and number of bugs corresponding to the original man-hour input of this project. At this time, as the prediction model, a machine learning model or a model defined in a rule-based manner may be used. For example, an estimation model based on a neural network may be used to predict the future total man-hour effort and number of bugs. This estimation model is machine-learned while the performance data such as the number of requirements, requirement complexity, the number of test cases, and development difficulty is used as explanatory variables and the performance data such as the total man-hour effort and the number of bugs is used as object variables, and hence, the total man-hour effort and the number of bugs are obtained by inputting the number of requirements, the complexity of the requirement, the number of test cases, the development difficult, and the like. Further, in order to increase a prediction accuracy, the milestone data 106 of this project and the milestone data on the project group of the past data 107 may be used (1302).

The analysis section 102 calculates the future productivity, bug density, and development period corresponding to the original man-hour input of this project on the basis of the future total man-hour effort, the value of the future number of bugs, and the values of the characteristic data 105 of this project (1303). As the prediction model, a machine learning model or a model defined in a rule-based manner should be used. For example, an estimation model based on a neural network may be used to predict the future total man-hour effort and number of bugs. This estimation model is machine-learned while the performance data such as the number of requirements, the requirement complexity, the number of test cases, and the development difficulty is used as explanatory variables and the performance data such as the total man-hour effort and the number of bugs is used as object variables, and hence, the total man-hour effort and the number of bugs are obtained by inputting the number of requirements, the complexity of the requirement, the number of test cases, the development difficulty, and the like.

After that, the future total man-hour effort, number of bugs, productivity, bug density, and development period corresponding to the original man-hour input of this project are displayed by the output section 103 (1304).

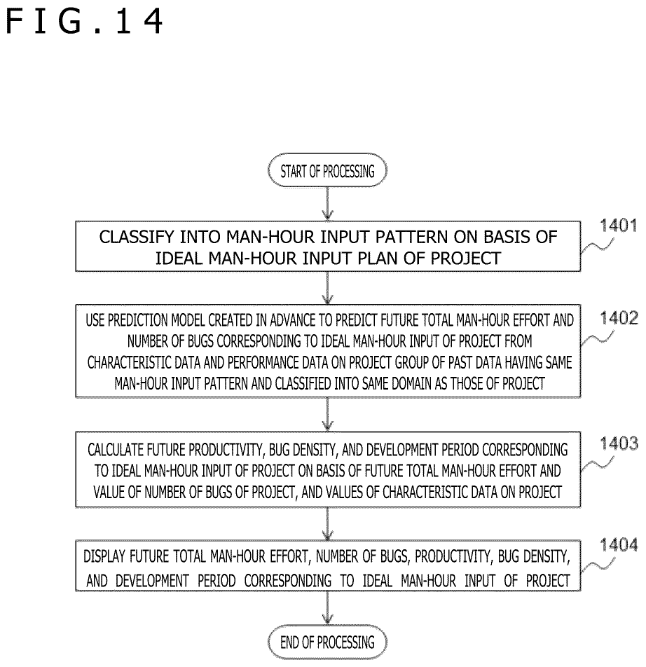

FIG. 14 is a flowchart of processing of calculating, by the analysis section 102, the future total man-hour effort, number of bugs, productivity, bug density, and development period in the ideal man-hour input plan.

The analysis section 102 collates the ideal man-hour input plan of this project displayed by the man-hour input plan input section 101 in the man-hour input graph 110 with the plurality of man-hour input patterns stored in advance, thereby classifying the input man-hour effort into a man-hour input pattern (1401). As the method of classifying into the pattern, adoptable are the method of employing the equation in the ideal form calculated from the average of the shape of the man-hour input plan, the method based on the definition of the flag, the pattern matching of the shape of the man-hour input plan, or other methods.

The analysis section 102 uses the prediction model created in advance from the characteristic data and the performance data on the project group of the past data 107 classified into the same man-hour input pattern and the same domain as those of this project to predict the future total man-hour effort and number of bugs corresponding to the ideal man-hour input of this project. At this time, as the prediction model, a machine learning model or a model defined in a rule-based manner should be used. For example, an estimation model based on a neural network should be used to predict the future total man-hour effort and number of bugs. This estimation model is machine-learned while the performance data such as the number of requirements, the requirement complexity, the number of test cases, and the development difficulty is used as explanatory variables and the performance data such as the total man-hour effort and the number of bugs is used as object variables, and hence, the total man-hour effort and the number of bugs are obtained by inputting the number of requirements, the complexity of the requirement, the number of test cases, the development difficulty, and the like. Further, in order to increase a prediction accuracy, the milestone data 106 of this project and the milestone data on the project group of the past data 107 may be used (1402).

The analysis section 102 calculates the future productivity, bug density, and development period corresponding to the ideal man-hour input of this project on the basis of the future total man-hour effort, the value of the future number of bugs, and the values of the characteristic data 105 of this project (1403). As the prediction model, a machine learning model or a model defined in in a rule-based manner may be used. For example, an estimation model based on a neural network may be used to predict the future total man-hour effort and number of bugs. This estimation model is machine-learned while the performance data such as the number of requirements, the requirement complexity, the number of test cases, and the development difficulty is used as explanatory variables and the performance data such as the total man-hour effort and the number of bugs is used as object variables, and hence, the total man-hour effort and the number of bugs are obtained by inputting the number of requirements, the complexity of the requirement, the number of test cases, the development difficulty, and the like.

After that, the future total man-hour effort, number of bugs, productivity, bug density, and development period corresponding to the ideal man-hour input of this project are displayed by the output section 103 (1404).

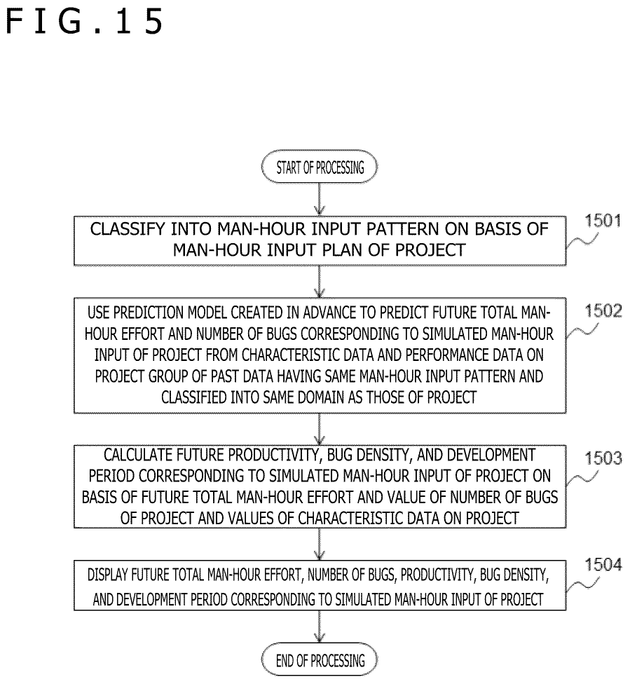

FIG. 15 is a flowchart of processing of calculating, by the analysis section 102, future total man-hour effort, number of bugs, productivity, bug density, and development period in the simulated man-hour input plan of this project.

The analysis section 102 classifies the input man-hour effort into a man-hour input pattern on the basis of the simulated man-hour input plan of this project displayed by the man-hour input plan input section 101 in the man-hour input graph 110 (1501). As the method of classifying into the pattern, the method of employing the equation in the ideal form calculated from the average of the shape of the man-hour input plan, the method based on the definition of the flag, the pattern matching of the shape of the man-hour input plan, or other methods can be employed.

The analysis section 102 uses the prediction model created in advance from the characteristic data and the performance data on the project group of the past data 107 classified into the same man-hour input pattern and the same domain as those of this project to predict the future total man-hour effort and number of bugs corresponding to the simulated man-hour input of this project. At this time, as the prediction model, a machine learning model or a model defined in a rule-based manner may be used. Further, in order to increase a prediction accuracy, the milestone data 106 of this project and the milestone data on the project group of the past data 107 may be used (1502).

The analysis section 102 calculates the future productivity, bug density, and development period corresponding to the simulated man-hour input of this project on the basis of the future total man-hour effort, the value of the future number of bugs, and the values of the characteristic data 105 of this project (1503).

After that, the future total man-hour effort, number of bugs, productivity, bug density, and development period corresponding to the simulated man-hour input of this project are displayed by the output section 103 (1504).

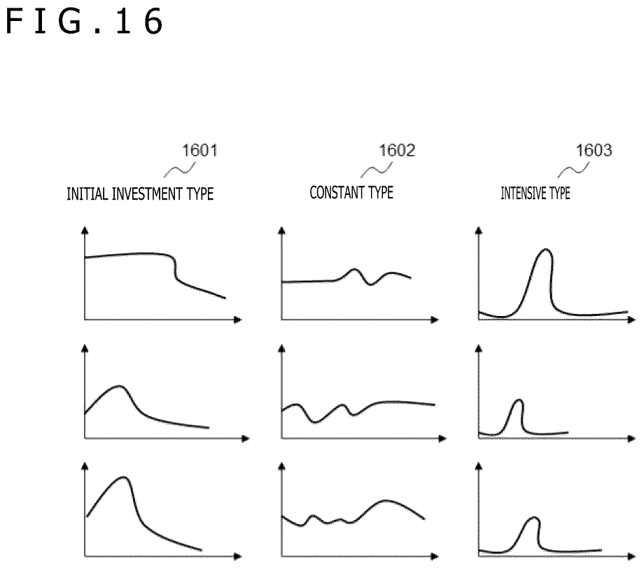

FIG. 16 is a chart for illustrating an example of “man-hour input patterns” in the processing illustrated in FIG. 13, FIG. 14, and FIG. 15.

The man-hour input pattern includes an initial investment type 1601 having a large investment amount in an early period, a constant type 1602 having a small change in investment amount during a period, and an intensive type 1603 having an investment concentrated in a specific period. The initial investment type 1601 is appropriate for a project for producing large-scale software by a large number of people. The constant type 1602 is appropriate for a project for modifying existing software. The intensive type 1603 is appropriate for creating small-scale software. These patterns are an example, and another pattern may be defined.

### Embodiment 2

In an embodiment 2, in addition to the embodiment 1, skill information on persons assigned to the project is also used when the man-hour input graph 110 displayed by the man-hour input plan input section 101 is calculated. That is, in the embodiment 2, the man-hour input plan is information on “how many man-hour efforts of persons having which skills are assigned to which month in the future in the project.” As a result, in the embodiment 2, the man-hour effort can be weighted according to the skills of the persons.

### Embodiment 3

In an embodiment 3, in addition to the embodiment 1, when the man-hour input graph 110 displayed by the man-hour input plan input section 101 is calculated, two pieces of information which are intra man-hour effort subject to development inside an organization and outsourced man-hour effort subject to development through outsourcing to the outside of the organization are used. That is, in the embodiment 3, the man-hour input plan includes two man-hour input graphs one of which represents original, ideal, and simulated man-hour input plan relating to the intra man-hour effort and the other one of which represents original, ideal, and simulated man-hour input plans relating to the outsourced man-hour effort.

### Embodiment 4

In an embodiment 4, in addition to the embodiment 1, when the man-hour input graph 110 displayed by the man-hour input plan input section 101 is calculated, an alert is displayed when a separation between the ideal and simulated man-hour input plans is large. As a display form of the alert, a text, a popup window, a dialog box, coloring of the man-hour input graph 110, and the like may be used.

### Embodiment 5

In an embodiment 5, in addition to the embodiment 1, in the display by the output section 103, an alert is displayed when a separation between the ideal and simulated man-hour input plans in at least one of the total man-hour effort, the number of bugs, the productivity, the bug density, and the development period is large. As a display form of the alert, a text, a popup window, a dialog box, coloring of the output screen, and the like may be used.

As described above, according to the project total man-hour effort/quality prediction simulation system 10 according to the embodiments, the project planner can highly accurately predict the quality and the total man-hour effort of the man-hour input plan.

Note that the present invention is not limited to the embodiments described above and includes various modification examples and equivalent configurations within the scope of the accompanying claims. For example, the embodiments described above are detailed for describing the present invention in an easy-to-understand manner, and the present invention is not necessarily limited to an embodiment including all of the described configurations. Moreover, the configurations of one of the embodiments may be partially replaced with those of the other embodiment. Further, the configurations of one of the embodiments may include the configurations of the other embodiment. Alternatively, the configurations of the embodiments may partially allow the addition of other configurations, deletion, and replacement.

Moreover, a part or all of each of the configurations, the functions, the processing sections, the processing means, and the like described above may be implemented through hardware by, for example, designing as an integrated circuit or may be implemented through software by a processor interpreting and executing a program which implements each function.

Information such as a program, a table, a file, and the like which implement each function can be stored in a storage device such as a memory, a hard disk, and a solid state drive (SSD) or a recording medium such as an IC card, an SD card, or a DVD.

Moreover, as a control line and an information line, ones required for the description are illustrated, and hence, all control lines and information lines required for the implementation are not always illustrated. It can be considered that almost all of the configurations are actually connected to one another.

1. A man-hour input plan generation system provided with a calculation device that executes predetermined calculation processing and a storage device connected to the calculation device, the man-hour input plan generation system comprising:
an input section in which the calculation device input of a man-hour input plan directed to a project;
an analysis section in which the calculation device analyzes the input man-hour input plan; and
an output section in which the calculation device outputs an analysis result obtained by the analysis section,
wherein the input section receives input of, as the man-hour input plan, time series data associating a man-hour input amount and an input time with each other-
wherein the analysis section
collates the input time-series data with a plurality of man-hour input patterns stored in advance, thereby identifying a corresponding man-hour input pattern,
extracts a past project common in a characteristic to the identified man-hour input pattern from among past projects stored in advance, and
predicts at least one of a total man-hour effort and a quality of the man-hour input plan on a basis of performance of the extracted past project, thereby outputting at least one of the total man-hour effort and the quality.

2. (canceled)

3. The man-hour input plan generation system according to claim 1,
wherein the input section receives, as the input, characteristic data relating to the project, and
the analysis section generates ideal time-series data on a basis of the input characteristic data.

4. The man-hour input plan generation system according to claim 3,
wherein the input section further receives, as the input, milestone data relating to the project, and
the analysis section generates the ideal time-series data on a basis of the milestone data in a past project.

5. The man-hour input plan generation system according to claim 1,
wherein the analysis section outputs the total man-hour effort or the quality as the analysis result of the input man-hour input plan in response to editing of the man-hour input plan by a user, and
the output section outputs the analysis result by the analysis section.

6. The man-hour input plan generation system according to claim 1,
wherein the input section further receives, as the input, milestone data relating to the project, and
the analysis section predicts at least one of the total man-hour effort or the quality on a basis of the milestone data in a past project.

7. The man-hour input plan generation system according to claim 1,
wherein the input section provides an interface which allows a user to change ideal time-series data with use of a GUI, thereby generating the man-hour input plan.

8. A man-hour input plan generation method executed by a man-hour input plan generation system, the man-hour input plan generation system being provided with a calculation device which executes predetermined calculation processing and a storage device connected to the calculation device, the man-hour input plan generation method comprising:
an input step of receiving, by the calculation device, input of a man-hour input plan directed to a project;
an analysis step of analyzing, by the calculation device, the input man-hour input plan; and
an output step of outputting, by the calculation device, an analysis result by the analysis step,
wherein, in the input step, the calculation device receives, as the man-hour input plan, input of time series data associating a man-hour input amount and an input time with each other-
wherein, in the analysis step, the calculation device
collates the input time-series data with a plurality of man-hour input patterns stored in advance, thereby identifying a corresponding man-hour input pattern,
extracts a past project common in a characteristic to the identified man-hour input pattern from among past projects stored in advance, and
predicts at least one of a total man-hour effort and a quality on a basis of performance of the extracted past project.

9. (canceled)

10. The man-hour input plan generation method according to claim 8,
wherein, in the input step, the calculation device receives, as the input, characteristic data relating to the project, and,
in the analysis step, the calculation device generates ideal time-series data on a basis of the input characteristic data.

11. The man-hour input plan generation method according to claim 10,
wherein, in the input step, the calculation device further receives, as the input, milestone data relating to the project, and,
in the analysis step, the calculation device generates the ideal time-series data on a basis of the milestone data in a past project.

12. The man-hour input plan generation method according to claim 8,
wherein, in the analysis step, the calculation device outputs the total man-hour effort or the quality as the analysis result of the input man-hour input plan in response to editing of the man-hour input plan by a user, and
in the output step, the calculation device outputs the analysis result in the analysis step.

13. The man-hour input plan generation method according to claim 8,
wherein, in the input step, the calculation device further receives, as the input, milestone data relating to the project, and
in the analysis step, the calculation device predicts at least one of the total man-hour effort or the quality on a basis of the milestone data in a past project.

14. The man-hour input plan generation method according to claim 8,
wherein, in the input step, the calculation device provides an interface which allows a user to change ideal time-series data with use of a GUI, thereby generating the man-hour input plan.
